(19) United States
(12) Patent Application Publication
(10) Pub. No.: US 2026/0307071 A1
(43) Pub. Date: Oct. 8, 2026

(54) SEPARATION BASKET

(71) Applicant: Gentueri Inc., Verona, WI (US)

(72) Inventor: Randolph James Nagy, Verona, WI (US)

(21) Appl. No.: 19/476,409

(22) PCT Filed: Apr. 29, 2024
(86) PCT No.: PCT/US2024/026753

§ 371 Date: Oct. 17, 2025

Related U.S. Application Data
(60) Provisional application No. 63/499,061, filed on Apr. 28, 2023.

(51) Int. Cl. B01L 3/00

(52) U.S. Cl. CPC B01L 3/5021; B01L 3/5029; B01L 2200/02; B01L 2300/0681; B01L 2300/12; B01L 2400/0683

(57) ABSTRACT

A separation basket comprising a cylindrical wall, a flange extending from die cylindrical wall, and a bottom surface terminating the cylindrical wall. The bottom surface further comprises a fluid director and a plurality of weak areas. The fluid director is disposed centrally on the bottom surface. The plurality of weak areas is arranged radially about the fluid director on the bottom surface. The weak areas are configured to fracture and create openings in the bottom surface when subjected to a force.

### CROSS-REFERENCE TO RELATED APPLICATIONS

This application claims priority to U.S. Provisional Patent Application No. 63/499,061 filed on Apr. 28, 2023, the entire contents of which are incorporated herein by reference.

### INTRODUCTION

Various medical and scientific tests involve collecting biological cell samples via swabs, scrappers, tape, cotton balls or other collection devices. Once collected, the cell samples must be separated from the collection device. A lysis buffer fluid may be used to separate target cell components from the collection device. The collection device and the lysis buffer fluid are placed in the separation basket, which is then placed in a receiving tube. The separation basket is subject to a force (e.g., a centrifugal force or a positive pressure), which creates an opening in the separation basket. The lysis buffer flows out of the opening into the receiving tube and the collection device remains in the separation basket. Then, the collected lysis buffer fluid can be analyzed in the selected scientific or medical test.

### SUMMARY

The disclosure provides, in one aspect, a separation basket comprising a cylindrical wall, a flange extending from the cylindrical wall, and a bottom surface terminating the cylindrical wall. The bottom surface comprises a fluid director disposes centrally on the bottom surface and a plurality of weak areas arranged radially around the fluid director. The weak areas are configured to fracture and create a plurality of openings, when subjected to a force between 400 and 12,000 relative centrifugal force.

The disclosure provides, in one aspect, a method for separating solutions containing sample components from a collection device in a separation basket. The method comprising coupling the separation basket to a receiving tube. Then, the collection device is inserted into the separation basket. Next, a lysis buffer fluid is introduced into the separation basket. The separation basket is then sealed with the collection device and the lysis buffer fluid inside. Next, the separation basket and the receiving tube are subjected to a force, such that at least one weak area of the separation basket breaks open. When at least one of the weak areas are broken, the lysis buffer fluid flows from the separation basket to the receiving tube.

The disclosure provides, in one aspect, a separation basket comprising a cylindrical wall, a flange extending from the cylindrical wall, a bottom surface terminating the cylindrical wall, and a filter. The bottom surface comprises a fluid director disposes centrally on the bottom surface and a plurality of weak areas arranged radially around the fluid director. The weak areas are configured to fracture and create an opening, when subjected to a force between 400 and 12,000 relative centrifugal force. The filter is coupled to the separation basket and is configured to capture a first biological material.

Other aspects of the technology will become apparent by consideration of the detailed description and accompanying drawings.

### BRIEF DESCRIPTION OF THE DRAWINGS

FIG. 1 illustrates a schematic side view of an exemplary sample separation assembly.

FIG. 2 illustrates a top perspective view of an exemplary separation basket.

FIG. 3 illustrates a bottom perspective view of the separation basket shown in FIG. 2.

FIG. 4 illustrates a side view of the separation basket shown in FIG. 2.

FIG. 5 illustrates a top view of the separation basket shown in FIG. 2.

FIG. 6 illustrates a bottom view of the separation basket shown in FIG. 2.

FIG. 7 illustrates a side sectional view of the separation basket shown in FIG. 2.

FIG. 8 illustrates perspective section view of a bottom surface of the separation basket shown in FIG. 2.

FIG. 9A illustrates another perspective section view of the bottom surface of the separation basket with a plurality of weak areas intact.

FIG. 9B illustrates another perspective section view of the bottom surface of the separation basket with the plurality of weak areas fractured.

FIG. 10 illustrates a close-up view of one of the weak areas on the bottom surface of the separation basket.

FIG. 11 illustrates a schematic side view of another embodiment of an exemplary separation basket of FIG. 1.

FIG. 12 illustrates a schematic side view of another embodiment of an exemplary separation basket of FIG. 1.

FIG. 13 illustrates a schematic side view of another embodiment of an exemplary separation basket of FIG. 1.

FIG. 14 illustrates a flow chart of a method of extracting a sample from a collection device using an exemplary sample separation assembly.

FIG. 15 is a bottom perspective view of a comparative separation basket used during experimental evaluation.

FIG. 16A is a bottom perspective view of an Example separation basket used during experimental evaluation.

FIG. 16B is a bottom plan view of the Example separation basket shown in FIG. 16A.

FIG. 17 shows exemplary cotton swabs used during the experiments.

FIG. 18 shows a top view of the Comparative separation basket and the Example separation basket with cotton swabs and lysis fluid.

FIG. 19 shows fluid in microcentrifuge tubes after centrifugation with the Comparative separation basket and the Example separation basket.

FIG. 20 shows fluid in microcentrifuge tubes after centrifugation with the Comparative separation basket and the Example separation basket.

Before any embodiments of the disclosure are explained in detail, it is to be understood that the invention is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

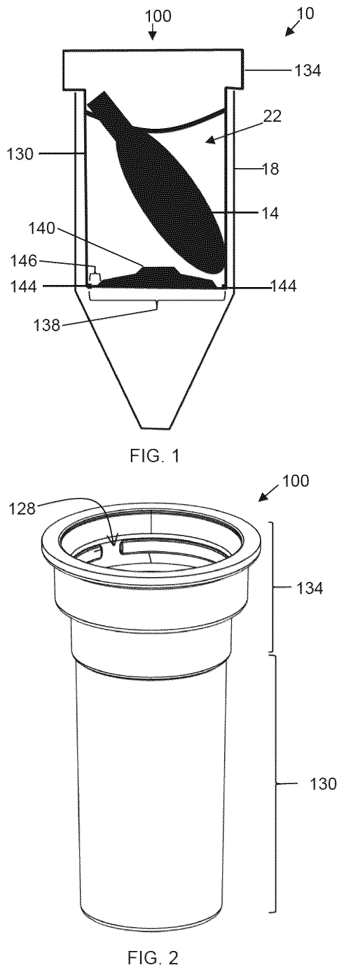

FIG. 1 shows a schematic side sectional view of a sample assembly 10. The sample assembly 10 is configured for processing and analysis operations. As shown, the sample assembly 10 includes a separation basket 100 and a receiving tube 18. A lysis buffer fluid 22 is within separation basket 100, and a collection device 14 is positioned in the lysis buffer fluid 22. Other embodiments may include more or fewer components.

The separation basket 100 is configured to hold the lysis buffer fluid 22 and the collection device 14. The separation basket 100 includes a cylindrical wall 130, a flange 134 extending from the cylindrical wall 130, and a bottom surface 138 terminating the cylindrical wall 130.

The bottom surface 138 includes a fluid director 140, a plurality of weak areas 144, and plurality of depressions 146. In one instance, the receiving tube 18 and separation basket 100 can be inserted into a centrifuge to separate the collection device 14 and sample components into the lysis buffer fluid 22. During operation of the centrifuge, weak areas 144 of the separation basket 100 are configured to open causing the lysis buffer fluid 22 to be transferred to the receiving tube 18.

In another instance, the separation basket 100 may receive pressurized air applying pressure to the lysis buffer fluid 22, which in turn applies pressure to the bottom surface 138. As a result, the weak areas 144 of the bottom surface 138 open and the lysis buffer fluid 22 is transferred into the receiving tube 18. The separation basket 100 may be made of medical grade polypropylene. Additional details regarding separation basket 100 are provided below with reference to FIGS. 2-10.

The receiving tube 18 is configured collect the lysis buffer fluid 22. The receiving tube 18 is configured to form a transition fit with the separation basket 100. The transition fit allows the separation basket 100 to be removed from the receiving tube 18 after an extraction process 500 is complete. The receiving tube 18 may be made of various materials, such as medical grade polypropylene or glass. In some embodiments, the receiving tube 18 may be a centrifuge tube, a microcentrifuge tube, a test tube, or a PCR tube.

The lysis buffer fluid 22 is used to separate the sample from the collection device 14 and/or break down the sample of cells into the target components. During extraction processes, the lysis buffer fluid 22 is introduced into the separation basket 100. Once the collection device 14 is submerged, the lysis buffer fluid 22 begins to break down the cell walls of the collected sample of cells on the collection device 14, and the target components are dissolved into the lysis buffer fluid 22. In the illustrated embodiment, the lysis buffer fluid is DNA extraction fluid. In some embodiments, the lysis buffer fluid 22 may be Radioimmunoprecipitation assay (RIPA) or nonyl phenoxypolyethoxylethanol (NP-40).

The collection device 14 is configured to collect cell samples from a target surface (not shown). Exemplary target surface may include an inner lining of a cheek, an inner surface of a nasal cavity, a portion of infected skin, a crime scene sample like a handle grip of a weapon or other evidence. The collection device 14 may be detached from a handle (not shown) to fit in the separation basket 100. The collection device 14 may be made of a material (i.e., natural fiber, synthetic fibers, or a biocompatible material) configured to collect biological material that hold the sample of the cells before an extraction process is conducted.

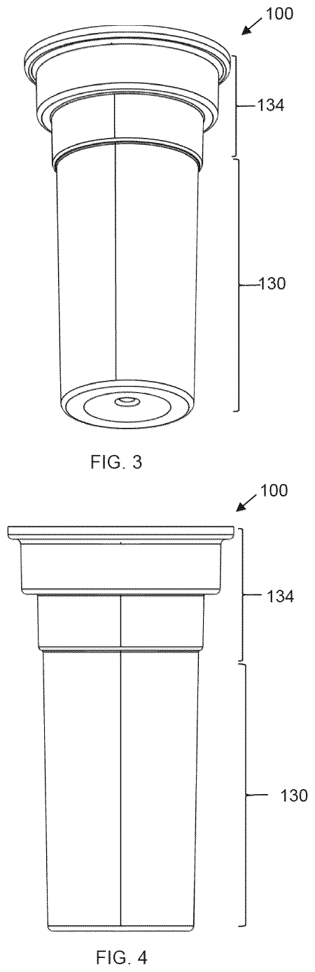

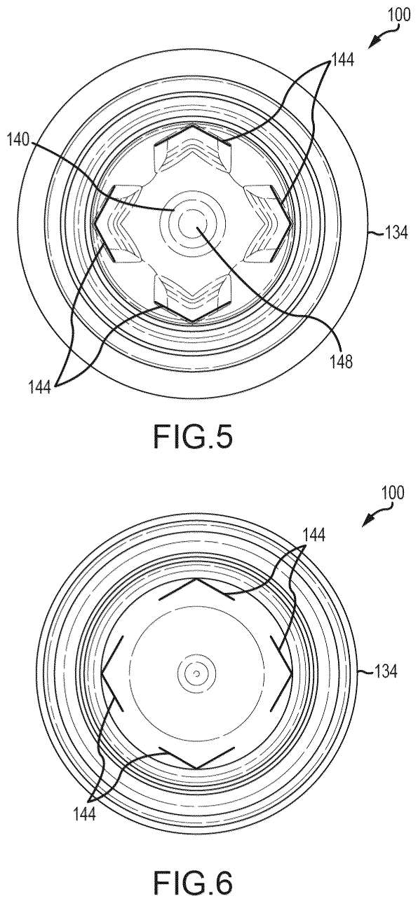

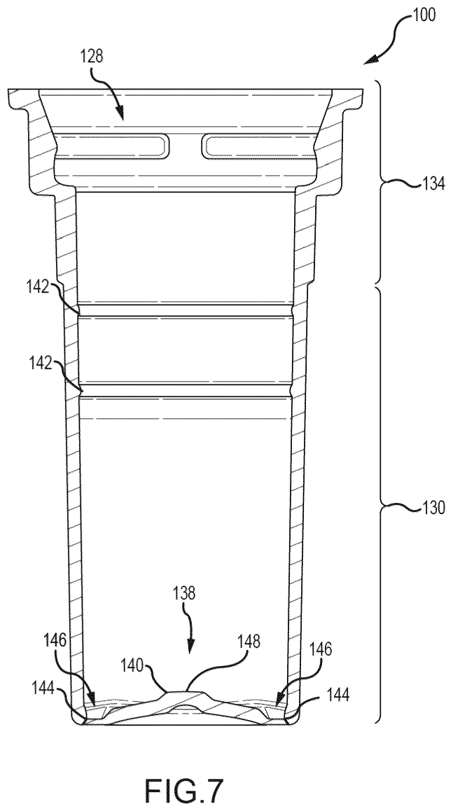

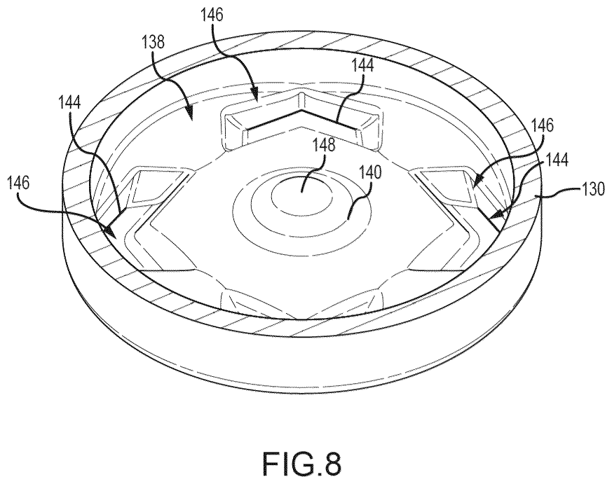

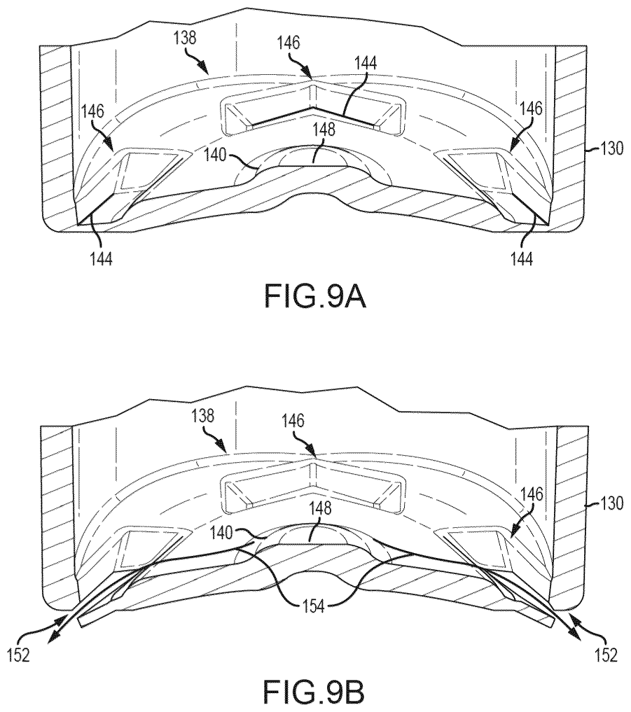

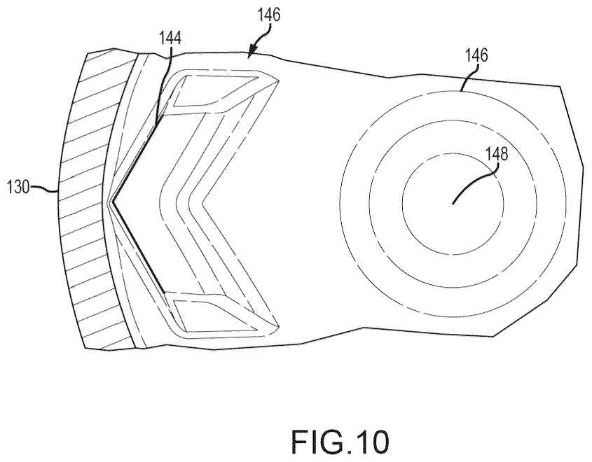

FIGS. 2-10 illustrate an exemplary separation basket 100 and are discussed concurrently below unless otherwise indicated. FIG. 2 is a top perspective view of separation basket 100. FIG. 3 is a bottom perspective view of the separation basket 100. FIG. 4 is a side view of the separation basket 100. FIG. 5 is a top view of the separation basket 100. FIG. 6 is a bottom view of the separation basket 100. FIG. 7 is a side sectional view of the separation basket 100. FIG. 8 is a perspective sectional view of the bottom surface 138 of the separation basket 100. FIG. 9A is another perspective section view of the bottom surface 138 of the separation basket 100 with the plurality of weak areas 144 intact. FIG. 9B is another perspective section view of the bottom surface of the separation basket 100 with the plurality of weak areas 144 fractured. FIG. 10 is a closeup top view of a weak area 144 and the fluid director 140 on the bottom surface 138 of the separation basket 100.

The cylindrical wall 130 of the separation basket 100 forms a basket inner volume 128 for holding the lysis buffer fluid 22 and the collection device 14. In some instances, the cylindrical wall 130 may include one or more fill indicators 142 extending into the basket inner volume 128. When the separation basket 100 is inserted into the receiving tube 18, the cylindrical wall 130 is concentric with the receiving tube 18. In the illustrated embodiment, the cylindrical wall 130 maintains a uniform diameter extending from the bottom surface 138 to the flange 134, except for the fill indicators 142. In other embodiments, the cylindrical wall 130 may have varying diameters between the bottom surface 138 and the flange 134.

When present, the fill indicators 142 of the basket inner volume 128 are inwardly extending protrusions, which are configured to indicate the amount of lysis buffer fluid 22 in the basket inner volume 128. In the illustrated embodiment, there are two fill indicators 142 spaced axially apart from one another. In other embodiments, the fill indicators 142 may be recesses in the cylindrical wall 130 or may be printed indica. Additionally, in further embodiments, there may be less than or more than two fill indicators 142.

The flange 134 of the separation basket 100 extends radially outward from the cylindrical wall 130. The flange 134 is configured to limit an insertion depth of the separation basket 100 into the receiving tube 18 by abutting a top of the receiving tube 18. In the illustrated embodiment, the flange 134 is circular and includes has a varying external surface diameter between a top of the cylindrical wall 130 and the top of the separation basket 100. In other embodiments, the flange 134 may be polygonal.

The bottom surface 138 of the separation basket 100 separates the basket inner volume 128 from the receiving tube 18. The bottom surface 138 includes varying thicknesses of materials to create different features, as shown in FIG. 7. Specifically, the bottom surface 138 includes a fluid director 140 and a plurality of weak areas 144, as shown in FIGS. 5 and 7-10.

The fluid director 140 is a convex feature located on a center 148 of the bottom surface 138, as seen in FIGS. 7-10. The fluid director 140 is configured to direct the lysis buffer fluid 22 to lower portions of the separation basket 100. This assists in the transfer of lysis buffer fluid 22 from the separation basket 100 to the receiving tube 18 along a fluid flow path 154. In other embodiments, the fluid director 140 may be cone shaped, pyramidal, or hemispherical.

The weak areas 144 are located around the center 148 of the bottom surface 138 and inside the depressions 146. In the embodiment shown, there are four weak areas 144 that are radially equally spaced apart from the center 148 and are equally spaced apart from each other, as seen in FIGS. 5 and 8. In other embodiments, the separation basket 100 may include different numbers of weak areas. In various implementations, the bottom surface 138 may define no greater than 2 weak areas 144; no greater than 6 weak areas 144; no greater than 8 weak areas 144; or no greater than 10 weak areas 144. In various implementations, the bottom surface 138 may define no fewer than 8 weak areas 1441; no fewer than 6 weak areas 144; no fewer than 4 weak areas 144; or no fewer than 2 weak areas 144. In an alternate embodiment, the bottom surface 138 may include a single, continuous weak area 144 defined by a ring encircling the fluid director 140.

As seen in FIGS. 9A and 10, the weak areas 144 have a horizontal cross section that is arrow shaped. In other embodiments, the cross section of the weak areas 144 may have a crescent shape, a rectangular shape, a circular shape, or an arc shape. The weak areas 144 are thinner than the remainder of the bottom surface 138, as seen in FIGS. 7 and 9A-B. As a result, when the separation basket 100 is subjected to a force, such as a centrifugal force or a positive pressure, the weak areas 144 are configured to fracture and create a plurality of openings 152 in the bottom surface 138, as shown in FIG. 9B. In other embodiments, the openings 152 can extend from the bottom surface 138 to part of the cylindrical wall 130.

For ease of reference, an amount of force needed to fracture the weak areas 144 is provided in terms of relative centrifugal force (RCF). The relative centrifugal force (RCF), can be measured in multiples of the standard acceleration due to gravity at the earth's surface (xg). The RCF of a specific centrifuge can be calculated using the following formula: RCF=(RPM/1000)²×r×11.18, where RPM is the rotational speed of the centrifuge in revolutions per minute and r is the centrifugal radius in centimeters (distance from the center of the turning axis to the bottom of the centrifuge).

When subjected to a relative centrifugal force (RCF) of more than 400 and less than 12,000, at least one of the weak areas 144 of the bottom surface 138 may fracture. The fracture may be caused by the contents of the separation basket 100 applying pressure to the bottom surface 138. If subjected to positive pressure from pressurized air, at least one of the weak areas 144 may fracture at an equivalent pressure applied to the bottom surface 138 as when 400 to 12,000 relative centrifugal force is applied.

In various implementations, a relative centrifugal force needed to fracture the weak areas 144 is between about 400 and about 12,000 relative centrifugal force; between 400 and 12,000 relative centrifugal force; between 1,000 and 10,000 relative centrifugal force; between 400 and 9,000 relative centrifugal force; between 1,000 and 9,000 relative centrifugal force; between 2,000 and 7,500 relative centrifugal force; between 1,000 and 5,000 relative centrifugal force: or between 3,000 and 8,000 relative centrifugal force. In various implementations, a relative centrifugal force needed to fracture the weak areas 144 is no greater than 12,000 relative centrifugal force; no greater than 11,000 relative centrifugal force; no greater than 10,000 relative centrifugal force; no greater than 9,000 relative centrifugal force; no greater than 8,000 relative centrifugal force: no greater than 7,000 relative centrifugal force; no greater than 5,000 relative centrifugal force; no greater than 4,000 relative centrifugal force; no greater than 3,000 relative centrifugal force; no greater than 2,000 relative centrifugal force; no greater than 1,000 relative centrifugal force; no greater than 800 relative centrifugal force; or no greater than 600 relative centrifugal force. In various implementations, a relative centrifugal force needed to fracture the weak areas 144 is no less than 600 relative centrifugal force: no less than 900 relative centrifugal force; no less than 1,200 relative centrifugal force; no less than 1,500 relative centrifugal force; no less than 1,900 relative centrifugal force; no less than 2,400 relative centrifugal force; no less than 3,400 relative centrifugal force; no less than 4,400 relative centrifugal force; no less than 5,400 relative centrifugal force; no less than 6,400 relative centrifugal force; no less than 7.400 relative centrifugal force; no less than 8,400 relative centrifugal force; no less than 9,400 relative centrifugal force; no less than 10,400 relative centrifugal force; or no less than 11,400 relative centrifugal force.

The depressions 146 are also located around the center 148 of the bottom surface 138, as seen in FIGS. 7-10. In the illustrated embodiment, the depressions 146 are radially equally spaced apart from the center 148 and are equally spaced apart from each other, as seen in FIG. 5. Each of the depressions 146 is configured to direct the lysis buffer fluid 22 towards at least one opening 152 along the fluid flow path 154. Additionally, the depressions 146 have a horizontal cross sections shaped as an arrow to match the cross section of the weak areas 144. In other embodiments, the horizontal cross section of the depressions 146 may be different from the weak areas 144 and may have a crescent shape, a rectangular shape, or an arc shape.

FIGS. 9A-10 show a closeup view of the bottom surface 138 of the separation basket 100. On the bottom surface 138, the weak areas may be positioned radially equally spaced apart from the center 148. As examples, and without limitation, for a bottom surface 138 having a radius of 4 mm the weak areas 144 may be positioned a distance from the center 148 that is no less than 2.0 mm away; no less than 2.5 mm away; no less than 3.0 mm away; no less than 3.5 mm away; no less than 3.75 mm away; or no less than 3.95 mm away. As examples, and without limitation, for a bottom surface 138 having a radius of 4 mm, the weak areas 144 may be positioned a distance from the center 148 that is no greater than 4.0 mm away; no greater than 3.0 mm away: no greater than 2.0 mm away.

Additionally, the weak areas 144 are positioned an equal distance away from the cylindrical wall 130. Specifically, the weak areas 144 are positioned 0.1 to 0.5 mm away from the cylindrical wall 130. In various implementations, the weak areas 144 may be positioned between 0.2 mm to 0.4 mm away from the cylindrical wall 130; between 0.3 mt to 0.6 mm away from the cylindrical wall 130; between 0.4 mm to 1 mm away from the cylindrical wall 130. In further implementations, the weak areas 144 may intersect the cylindrical wall 130.

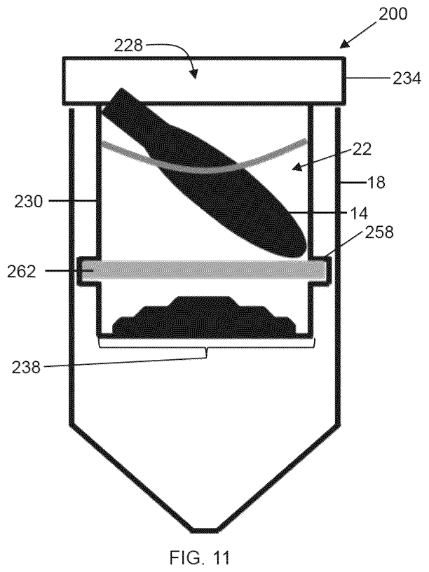

FIG. 11 shows a schematic side sectional view of another embodiment of a separation basket 200, with like parts to separation basket 100. The illustrated embodiment in FIG. 11 having like reference numerals in the range of 200 to 299, and the differences are explained below. The separation basket 200 is configured to hold the lysis buffer fluid 22 and the collection device 14 and can be inserted into the receiving tube 18. The separation basket 200 includes a cylindrical wall 230, a flange 234 extending from the cylindrical wall 230, and a bottom surface 238 terminating the cylindrical wall 230.

The cylindrical wall 230 forms a basket inner volume 228 and includes an integrally formed filter retaining feature 258. The basket inner volume 228 is configured to hold the lysis buffer fluid 22 and the collection device 14.

The filter retaining feature 258 is a recess formed circumferentially on the inner surface of the cylindrical wall 230 and has a diameter larger than the remainder of the cylindrical wall 230. The filter retaining feature 258 is configured to receive a filter 262, which is inserted into the separation basket 200 during manufacturing. In some embodiments, more than one filter 262 may be installed into the filter retaining feature 258 during manufacturing and each filter 262 may be configured to capture a different type of material. In other embodiments, the filter retaining feature 258 may be one or more O-rings coupled to the filter 262. The one or more O-rings are sized to create a push-fit with the basket inner volume 228 and maintain the position of the filter 262 in the basket inner volume 228.

The filter 262 is configured to limit the passage of material larger than the diameter of the pores. In some embodiments, the filter 262 may be coated in an antibody and/or may have an electrical charge, each of which are configured to capture and prevent specific material from passing through the filter 262. The filter 262 may be composed of PTFE or other biocompatible materials. In the illustrated embodiment, the diameters of the pores are approximately 4 microns but in other embodiments the diameter of the pores may be larger or smaller than 4 microns. As a result, material larger than the diameter of the pores remains on one side of the filter 262, while smaller material passes through. In some embodiments, the filter 262 will allow the passage of epithelial DNA, while limiting the passage of sperm cells. In other embodiments, the filter may separate proteins, lipids, cell components, bacteria, viruses, or toxins from the lysis buffer fluid 22.

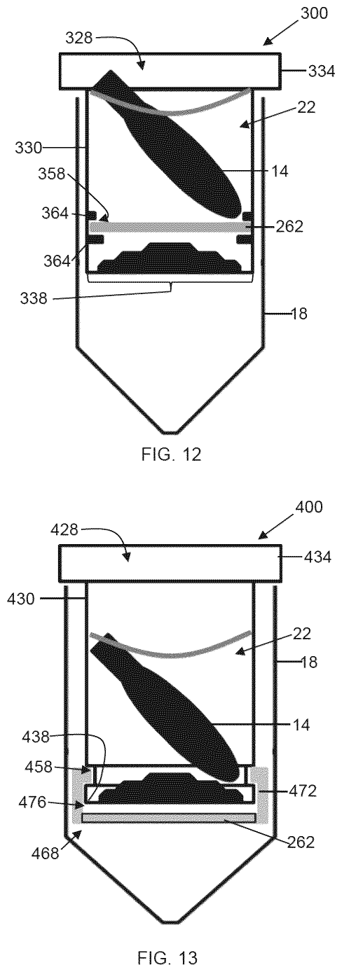

FIG. 12 shows a schematic side sectional view of another embodiment of a separation basket 300, with like parts to separation basket 100. The illustrated embodiment in FIG. 12 having like reference numerals in the range of 300 to 399, and the differences are explained below. The separation basket 300 is configured to hold the lysis buffer fluid 22 and the collection device 14 and can be inserted into the receiving tube 18. The separation basket 300 includes a cylindrical wall 330, a flange 334 extending from the cylindrical wall 330, and a bottom surface 338 terminating the cylindrical wall 330.

The cylindrical wall 330 forms a basket inner volume 328 and a filter recess 358. The basket inner volume 328 is configured to hold the lysis buffer fluid 22 and the collection device 14. The filter recess 358 is configured to receive the filter 262 and is defined by a set of filter retaining features 364. The filter recess 358 has a diameter equivalent to the remainder of the cylindrical wall 330.

The filter retaining features 364 are a set of inward extending protrusions formed circumferentially on the inner surface of the cylindrical wall 330. In the illustrated embodiment, one of the filter retaining features 364 extends further inward into the basket inner volume 328 than the other one of the filter retaining features 364. In other embodiments, both filter retaining features 364 may extend the same distance inward into the basket inner volume 328. In the illustrated embodiment, the filter retaining features 364 are continuous protrusions along an entire inner circumference of the cylindrical wall 330. In other embodiments, the filter retaining features 364 may be non-continuous and include a plurality of protrusions arranged circumferentially along the inner circumference of the cylindrical wall 330. The filter retaining features 364 are configured to receive the filter 262 during manufacturing. In some embodiments, more than one filter 262 may be installed into the filter retaining features 364 during manufacturing.

FIG. 13 shows a schematic side sectional view of another embodiment of a separation basket 400, with like parts to separation basket 100. The illustrated embodiment in FIG. 13 having like reference numerals in the range of 400 to 499, and the differences are explained below.

The separation basket 400 is configured to hold the lysis buffer fluid 22 and the collection device 14 and be inserted into the receiving tube 18. The separation basket 400 includes a cylindrical wall 430, a flange 434 extending from the cylindrical wall 430, and a bottom surface 438 terminating the cylindrical wall 430.

The cylindrical wall 430 forms a basket inner volume 428 and a filter retaining feature 458. The basket inner volume 228 is configured to hold the lysis buffer fluid 22 and the collection device 14. In the illustrated embodiment, the filters retaining feature 458 is a recess circumferentially formed on the outer surface of the cylindrical wall 430 and has a smaller diameter than the remainder of the cylindrical wall 430. In another embodiment, the filter retaining feature 458 may be a plurality of protrusions extending from the cylindrical wall 430. The filter retaining feature 458 is configured to receive a portion of a filter assembly 468. The filter assembly 468 includes a filter 262 and a coupling mechanism 472.

The coupling mechanism 472 engages the filter retaining feature 458 of the separation basket 400. In the illustrated embodiment, the coupling mechanism 472 is an annular snap fit joint, but in other embodiments the coupling mechanism 472 may be a cantilevered snap joint, a set of threads, or a portion of a bayonet mechanism.

During manufacturing, the annular snap fit joint of the coupling mechanism 472 is expanded and inserts the separation basket 400 leading with the bottom surface 438. The separation basket 400 is inserted until the annular snap fit joint contacts the filer retaining feature 458, and the motion of the filter assembly 468 is limited. When the filter assembly 468 is installed, a gap 476 is formed between the outer surface of the separation basket 400 and the filter 262 of the filter assembly 468. The gap 476 provides space for fractured portions of the bottom surface 438 to pivot outward and allow the flow of the lysis buffer fluid 22 out of the separation basket 400.

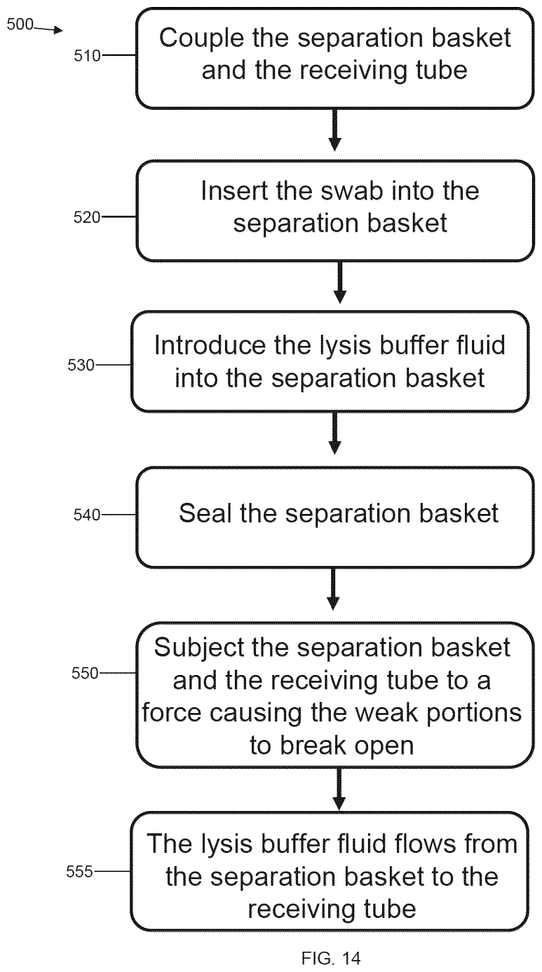

FIG. 14 is a flow chart illustrating the operations of and exemplary extraction process 500. The exemplary extraction process 500 can be performed with any of the separation baskets 100, 200, 300, 400.

During an exemplary extraction process 500, a user inserts the separation basket into the receiving tube, until the flange prevents further insertion (operation 510). Next, the user must place the collection device with the collected of sample of cells into the basket inner volume (operation 520).

Then, a specified amount of the lysis buffer fluid is introduced into the basket inner volume over the collection device (operation 530). If desired, the user may couple a filter or the filter assembly to the separation basket. The user then seals the separation basket (operation 540) and waits a defined amount of time, at the temperature directed by the reagent supplier, to allow for the lysis buffer fluid to break down the cells into the desired components. The receiving tube and the separation basket are subjected to a force to fracture at least one of the weak areas of the bottom surface (operation 550). If a centrifuge is used to subject the receiving tube and the separation basket to the force, the centrifuge may apply a centrifugal force of at least 400 relative centrifugal force and no greater than 12,000 relative centrifugal force If pressurized air is used to subject the receiving tube and the separation basket to the force, the pressurized air will apply an equivalent pressure to that experienced in the centrifuge at 400 to 12,000 relative centrifugal force.

During the operation of the centrifuge, at least one of the weak areas of the separation basket are fractured and the openings are created in the bottom surface, as shown in FIG. 9B. As a result, the lysis buffer fluid is transferred from the separation basket to the receiving tube (operation 555) along the fluid flow path, while the collection device remains in the separation basket. The fluid director aids in the transfer of the lysis buffer fluid by preventing lysis buffer fluid from settling on the bottom surface of the separation basket. Instead, the fluid director directs the lysis buffer fluid into the receiving tube. As the lysis buffer fluid is transferred from the separation basket to the receiving tube, the desired components can be caught by a filter (not shown). Once a majority of the lysis buffer fluid is transferred to the receiving tube, the separation basket can be uncoupled and discarded.

### Experimental Data

An exemplary embodiment of the separation basket was manufactured and experimentally evaluated. Various aspects of the experiments are described below.

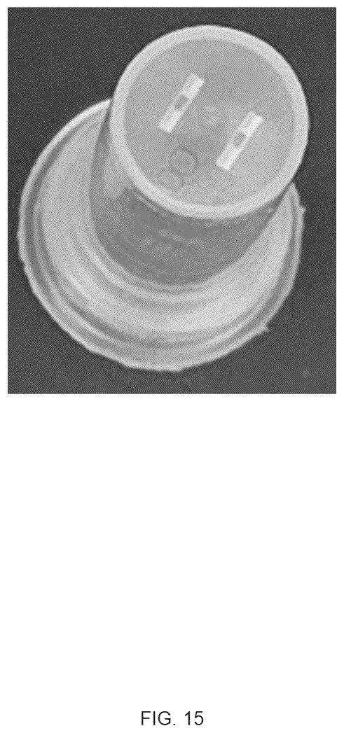

FIG. 15 shows a bottom perspective view of a Comparative separation basket. As shown, the Comparative separation basket was made of medical grade polypropylene and has two parallel, V-shaped slits on a flat bottom surface. The V-shaped slits are positioned on opposite sides of the center point of the bottom surface. The V-shaped slits are positioned closer to the center point of the bottom surface than the edge where the bottom surface meets the inner cylindrical wall.

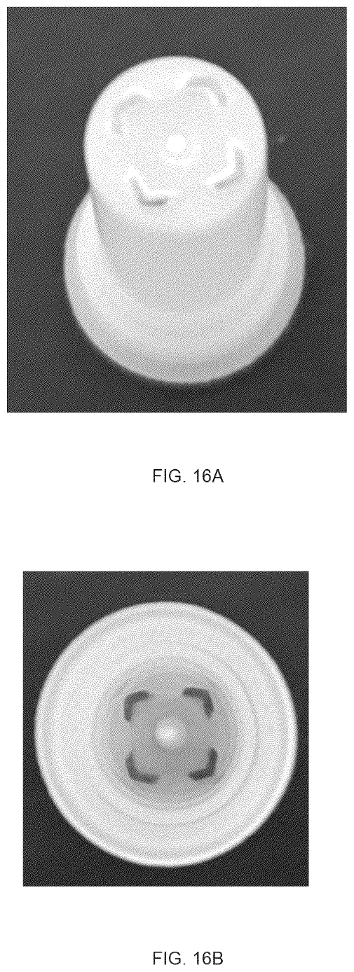

FIG. 16A shows a bottom perspective view of an experimental Example separation basket, and FIG. 16B shows a bottom plan view of the prototype shown in FIG. 16A. The Example separation basket was made of medical grade polypropylene and included four weakened areas on the bottom surface, disposed adjacent to the edge whether the bottom surface meets the inner cylindrical wall.

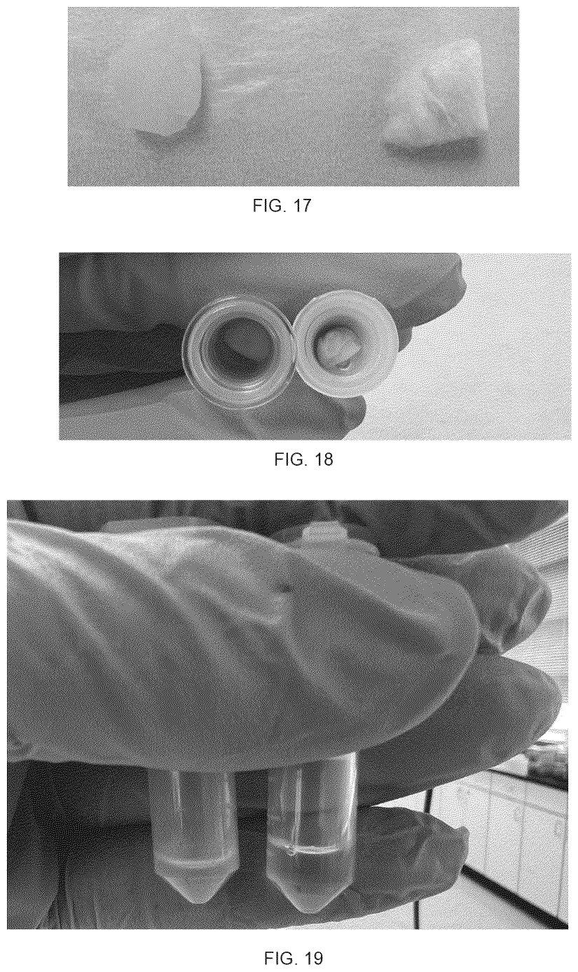

During the experiments, cotton swabs, as shown in FIG. 17, were positioned in the Comparative sample basket and the Example separation basket. 300 μL of lysis buffer fluid was provided into the Comparative sample basket and 300 μL of lysis buffer fluid was provided into the Example sample basket. FIG. 18 is a top view of the two sample baskets with cotton swabs and lysis fluid.

In a first set of experiments, four saliva samples were tested in the Comparative and Example separation baskets. The separation baskets, positioned within a 2 mL microcentrifuge tubes (a receiving tube), were placed inside a commercial centrifuge and spun at 10,000 relative centrifugal force for 5 minutes. Table 1 below shows the results of liquid that passed through the separation baskets and into the microcentrifuge tubes.

TABLE 1
Amount of fluid for saliva samples in microcentrifuge
tube after centrifugation.

| | Comparative separation | Example separation |
|---|---|---|
| Sample Name | basket (ng/ul) | basket (ng/ul) |
| A | 0.157 | 0.817 |
| B | 0.172 | 0.658 |
| C | 0.061 | 0.102 |
| D | 1.164 | 2.994 |

In a second set of experiments, six cell phone samples were tested in the Comparative and Example separation baskets. The separation baskets, positioned within 2 mL microcentrifuge tubes, were placed inside a commercial centrifuge and spun at 10,000 relative centrifugal force for 5 minutes. Table 2 below shows the results of liquid that passed through the separation baskets and into the microcentrifuge tubes.

TABLE 2
Amount of fluid for cell phone samples in
microcentrifuge tube after centrifugation.

| | Comparative separation | Example separation |
|---|---|---|
| Sample | basket (ng/ul) | basket (ng/ul) |
| 1 | 0.0030 | 0.0120 |
| 2 | 0.0030 | 0.0310 |
| 3 | 0.0020 | 0.0100 |
| 4 | 0.0090 | 0.1220 |
| 5 | Undetected | Undetected |
| 6 | 0.0020 | 0.2190 |

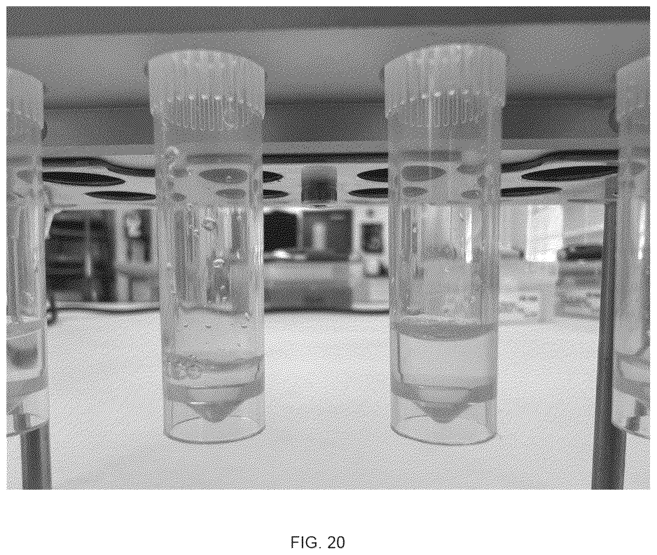

As shown in Table 1 and Table 2, in FIG. 19 and FIG. 20 where the Comparative separation basket is on the left and the Example separation basket is on the right, the Example separation baskets direct more fluid to the microcentrifuge tube than the Comparative separation baskets.

In a third set of experiments, three mock sexual assault samples were prepared on swabs and were tested in the Experimental example separation basket. For each experiment, the swab was dried and then was trimmed to a length less than 1.5 cm. Then, a filter was coupled to the Experimental example separation basket and the prepared swab was placed within the inner volume of the Experimental example separation basket. The Experimental example separation basket was placed within a 1.5 mL or 2 mL microcentrifuge tube (the receiving tube). Next, 470 μL of an epithelial digest solution and 30 μL of proteinase K (20 mg/mL) were added to the inner volume of the Experimental example separation basket, and the Experimental example separation basket was sealed.

Once sealed, the microcentrifuge tube and the Experimental example separation basket were moved in a vortex pattern for 10 seconds to mix the contents within the inner volume of the Experimental example separation basket. Then, the microcentrifuge tube with the Experimental example separation basket was placed in a thermomixer at 56° C. for 1.5 hours with 900 rpm shaking. Once removed from the thermomixer, the microcentrifuge tube and the Experimental example separation basket were placed in a centrifuge at 5000× g for 3 minutes. While in the centrifuge, the epithelial digest solution and the proteinase K were released from the Experimental example separation basket and were transferred into the microcentrifuge tube. Once removed from the centrifuge, the Experimental example separation basket was removed from the microcentrifuge tube and the contents of the microcentrifuge tube were stored for future processing. The contents of the microcentrifuge were considered a first epithelial fraction.

The Experimental example separation basket was then placed in a new microcentrifuge tube. Then, 435 μL of epithelial digest solution and 15 μL of proteinase K (20 mg/mL) were added to the inner volume of the Experimental example separation basket, and the Experimental example separation basket was sealed. Once sealed, the microcentrifuge tube and the Experimental example separation basket were moved in a vortex pattern for 10 seconds to mix the contents within the inner volume of the separation basket. Then, the microcentrifuge tube and the Example separation basket were placed in a thermomixer at 56° C. for 30 min with 900 rpm shaking. Once removed from the thermomixer, the microcentrifuge tube and the Experimental example separation basket were placed in a centrifuge at 5000× g for 3 minutes. While in the centrifuge, the epithelial digest solution and the proteinase K were released from the Experimental example separation basket and were transferred into the microcentrifuge tube. Once removed from the centrifuge, the Experimental example separation basket was removed from the microcentrifuge tube and the contents of the microcentrifuge tube were stored for future processing. The contents of the microcentrifuge were also considered a second epithelial fraction.

The Experimental example separation basket was placed in another new microcentrifuge tube for a first wash. Then, 400 μL of sperm digest solution was added to the inner volume of the Experimental example separation basket, and the Experimental example separation basket was sealed. Once sealed, the microcentrifuge tube and the Experimental example separation basket were moved in a vortex pattern for 10 seconds to mix the contents within the inner volume of the Example separation basket. Then, the microcentrifuge tube and the Experimental example separation basket were placed in a centrifuge at 5000× g for 3 minutes. While in the centrifuge, the sperm digest solution was transferred into the microcentrifuge tube from the Experimental example separation basket. Once removed from the centrifuge, the separation basket was removed from the microcentrifuge tube and the contents are discarded

The Experimental example separation basket was placed in another new microcentrifuge tube for a second wash. Then, 450 μL of sperm digest solution was added to the inner volume of the Experimental example separation basket, and the Experimental example separation basket was sealed. Once sealed, the microcentrifuge tube and the Experimental example separation basket were moved in a vortex pattern for 10 seconds to mix the contents within the inner volume of the Example separation basket. Then, the microcentrifuge tube and the Experimental example separation basket were placed in a centrifuge at 5000×g for 3 minutes. Once removed from the centrifuge, the Experimental example separation basket was removed from the microcentrifuge tube and the contents of the microcentrifuge tube are discarded.

The Experimental example separation basket was placed in another new microcentrifuge tube for a third wash. Then, 400 μL of sperm digest solution was added to the inner volume of the Experimental example separation basket, and the Experimental example separation basket was sealed. Once sealed, the microcentrifuge tube and the Experimental example separation basket were moved in a vortex pattern for 10 seconds to mix the contents within the inner volume of the separation basket. Then, the microcentrifuge tube and the Experimental example separation basket were placed in a centrifuge at 5000× g for 3 minutes. Once removed from the centrifuge, the sperm digest solution was transferred into the microcentrifuge tube and the contents of the microcentrifuge tube are discarded.

The Experimental example separation basket was placed in another new microcentrifuge tube. Then, 450 μL of a sperm digest mixture (composed of 345 μL sperm digest solution, 25 μL of proteinase K (20 mg/mL), and 80 μL of Dithiothreitol (DTT) (M)) was added to the inner volume of the Example separation basket, and the Example separation basket was sealed. Once sealed, the microcentrifuge tube and the Example separation basket were moved in a vortex pattern for 10 seconds to mix the contents within the inner volume of the Example separation basket. Then, the microcentrifuge tube and the Example separation basket were placed in a thermomixer at 63° C. for 45 minutes with 900 rpm shaking. Once removed front the thermomixer, the microcentrifuge tube and the Example separation basket were placed in a centrifuge at 5000× g for 3 minutes. Then, the sperm digest mixture was released from the Example separation basket and was transferred into the microcentrifuge tube. Once removed from the centrifuge, the Example separation basket was removed from the microcentrifuge tube and the contents of the microcentrifuge tube were stored for future processing. The contents of the microcentrifuge were considered the sperm fraction.

Now, the epithelial fraction, the wash, and the sperm fraction previously saved from the contents of the previous microcentrifuge tubes were purified for DNA using a InnoXtract Forensic DNA Extraction and Purification Kit. Table 3 below shows the amount of male DNA separated from the sperm fraction and the combination of the epithelial fraction and the wash for each of the three samples. Table 4 below shows the percentage of the total male DNA recovered from both the sperm fraction and the combination of the epithelial fraction and the wash.

TABLE 3
Amount of Y-DNA recovered in ng for
three similar samples by two methods.

| | | Total Y-DNA |
|---|---|---|
| Sample | Solution | Recovered (ng) |
| 1 | First and Second Epithelial Fractions | 2.95 |
| 1 | Sperm Fraction | 9.75 |
| 2 | First and Second Epithelial Fractions | 3.34 |
| 2 | Sperm Fraction | 11.88 |
| 3 | First and Second Epithelial Fractions | 2.79 |
| 3 | Sperm Fraction | 15.29 |

TABLE 4
Percent of total Y-DNA recovered from three samples.

| Sample | Percent Y-DNA Recovered |
|---|---|
| 1 | 77 |
| 2 | 78 |
| 3 | 85 |

As shown in Table 4, across the 3 samples tested, the Example separation basket (FIG. 19-20 left separation basket) were able to recover an average of 80% of the total Y-DNA present on the sample swabs. The currently available methods were only able to recover less than 30% of the total Y-DNA present on the sample swabs.

In a fourth set of experiments, two buccal epithelial cell samples were collected using swabs. Each swab was placed in a 2 mL microcentrifuge tube (the receiving tube) filled with 500 μL of Accumax cell dissociation solution. Each microcentrifuge tube and the swab were placed in a thermomixer and are incubated at 400 RPM for 15 minutes at room temperature. Once removed from the thermomixer, the swabs were removed, and the remaining contents of both microcentrifuge tubes were combined and further incubated at 400 RPM for 15 minutes at room temperature.

The above contents of the microcentrifuge tubes (epithelial cell solution) were diluted with IX phosphate-buffered saline (PBS) to form four solutions with distinct concentrations (500, 250, 50, and 25 μg/μL). Next, for each concentration, six swabs were prepared by applying 20 μL of the solution to each swab. Each swab was left to air dry overnight under a fume hood. Also, a positive control group was formed by pipetting 20 μL of each concentration into a lysis buffer fluid.

Each swab was trimmed and then was placed into a 2 mL microcentrifuge tube along with 500 μL of lysis buffer fluid. The microcentrifuge tubes were all placed in a thermomixer set at 900 RPM for 1 hour at 56° C. Then, each swab was removed from the microcentrifuge tube. Now, for each concentration, three swabs were placed in three Example separation baskets and the remaining three swabs were placed in three Comparative separation baskets. Afterwards, both the Example separation baskets and the Comparative separation baskets were placed in microcentrifuge tubes and were sealed. The swabs, the separation baskets, and the microcentrifuge tubes were all placed in a centrifuge set to 10,000×g for 1 minute. The centrifuge process was repeated twice. In the centrifuge, the lysis buffer fluid was transferred from the separation baskets to the microcentrifuge tube. After removal from the centrifuge, the separation baskets and the swabs were removed from the microcentrifuge tubes and are discarded. The contents of the microcentrifuge tube were purified for DNA using the EZ1 large volume protocol (QIAGEN) and 50 μL of Tris-EDTA (TE) buffer. Table 5 shows a comparison of the performance of different separation methods in separating Y-DNA from the swab.

TABLE 5
Comparison between different methods of separation.

| | Initial Y-DNA Concentration | | | | | | | |
|---|---|---|---|---|---|---|---|---|
| Method of | 500 | pg/μL | 250 | pg/μL | 50 | pg/μL | 25 | pg/μL |
| Separation | | | | | | | | |
| Direct | 220 | pg/μL | 140 | pg/μl | 20 | pg/μl | 10 | pg/μl |
| Extraction | | | | | | | | |
| Comparative | 150 | pg/μl | 80 | pg/μl | 9 | pg/μl | 10 | pg/μl |
| Separation | | | | | | | | |
| Basket | | | | | | | | |
| Example | 190 | pg/μl | 150 | pg/μl | 10 | pg/μl | 10 | pg/μl |
| Separation | | | | | | | | |
| Basket | | | | | | | | |

As shown in Table 5, in FIG. 19 and FIG. 20 where the Comparative separation basket is on the left and the Example separation basket is on the right, the lysis buffer fluid from the Example separation basket had a higher concentration of DNA than the lysis buffer fluid from the Comparative separation basket. Furthermore, the p-values for the 10 ng and 5 ng solutions were under 0.05 indicating that the results of the experiments are highly reproducible.

For reasons of completeness, the following Clauses are provided.
Clause 1. A separation basket, comprising: a cylindrical wall: a flange extending from the cylindrical wall; and a bottom surface terminating the cylindrical wall, the bottom surface comprising: a fluid director disposed centrally on the bottom surface; and a plurality of weak areas arranged radially about the fluid director, where at least one of the weak areas fracture and create an opening when subjected to a force between 400 and 12,000 relative centrifugal force.
Clause 2. The separation basket according to clause 1, wherein the weak areas are radially equally spaced from a center of the bottom surface.
Clause 3. The separation basket according to clause 1 or clause 2, wherein the weak areas are equally spaced from each other.
Clause 4. The separation basket according to any one of the clauses 1-3, the bottom surface comprising between 2 to 8 weak areas.
Clause 5. The separation basket according to any one of the clauses 1-4, the weak areas having an arrow-shaped horizontal cross section.
Clause 6. The separation basket according to any one of the clauses 1-4, the weak areas having a crescent-shaped horizontal cross section.
Clause 7. The separation basket according to any one of the clauses 1-6, wherein each weak area is configured to fracture under a 400-9,000 relative centrifugal force.
Clause 8. The separation basket according to any one of the clauses 1-, wherein the fracture of the weak areas creates an opening in the bottom surface that extends to the cylindrical wall
Clause 9. A method for separating solutions comprising sample components from a collection device in a separation basket, the separation basket comprising a cylindrical wall, a flange formed on the cylindrical wall, and a bottom surface terminating the cylindrical wall, the bottom surface comprising a fluid director and a plurality of weak areas, the method comprising: coupling the separation basket to a receiving tube: inserting the collection device into the separation basket; introducing a lysis buffer fluid into the separation basket; sealing the collection device and the lysis buffer fluid in the separation basket; and subjecting the separation basket and the receiving tube to a force such that at least one weak area break open in the separation basket, whereupon the lysis buffer fluid flows from the separation basket to the receiving tube.
Clause 10. The method according to clause 9 wherein subjecting the separation basket and the receiving tube to the force using a centrifuge.
Clause 11. The method according to clause 9, wherein subjecting the separation basket and the receiving tube to the force through pressurized air.
Clause 12. The method according to any one of the clauses 9-11, wherein isolating the sample components of the solution from the collection device is achieved by submerging the collection device in the lysis buffer fluid to break a plurality of cells open and isolate the components.
Clause 13. The method according to any one of the clauses 9-12, further comprising removing the separation basket from the receiving tube.
Clause 14. A sample separation assembly, comprising: a separation basket comprising: a cylindrical wall, a flange extending from the cylindrical wall, and a bottom surface terminating the cylindrical wall, the bottom surface comprising: a fluid director disposed centrally on the bottom surface, and a plurality of weak areas arranged radially about the fluid director, where at least one of the weak areas fracture and create an opening when subjected to a force between 400 and 12,000 relative centrifugal force; and a filter coupled to the separation basket; the filter configured to capture the flow of a first biological material.
Clause 15. The sample separation assembly of clause 14, wherein the filter is coupled to a filter retaining feature on an outer surface of the separation basket.
Clause 16. The sample separation assembly of clause 14, wherein the filter is coupled adjacent to a bottom exterior surface of the separation basket.
Clause 17. The sample separation assembly as in any one of the clauses 14-wherein the filter is coupled to a filter retaining feature on an inner surface of the separation basket.
Clause 18. The sample separation assembly as in any one of the clauses 14-17, wherein the filter is coupled to the separation basket via a snap fit.
Clause 19. The sample separation assembly as in any one of the clauses 14-18, wherein the filter is composed of PTFE.

1. A separation basket, comprising:
a cylindrical wall;
a flange extending from the cylindrical wall; and
a bottom surface terminating the cylindrical wall, the bottom surface comprising:
a fluid director disposed centrally on the bottom surface; and
a plurality of weak areas arranged radially about the fluid director, where at least one of the plurality of weak areas fracture and create an opening when subjected to a force between 400 and 12,000 relative centrifugal force.

2. The separation basket according to claim 1, wherein the plurality of weak areas are radially equally spaced from a center of the bottom surface.

3. The separation basket according to claim 1, wherein the plurality of weak areas are equally spaced from each other.

4. The separation basket according to claim 1, the bottom surface comprising between 2 to 8 weak areas.

5. The separation basket according to claim 1, the plurality of weak areas having an arrow-shaped horizontal cross section.

6. The separation basket according to claim 1, the plurality of weak areas having a crescent-shaped horizontal cross section.

7. The separation basket according to claim 1, wherein each of the plurality of weak areas is configured to fracture under a 400-9,000 relative centrifugal force.

8. The separation basket according to claim 1, wherein a fracture of one of the plurality of weak areas creates an opening in the bottom surface that extends to the cylindrical wall.

9. A method for separating solutions comprising sample components from a collection device in a separation basket, the separation basket comprising a cylindrical wall, a flange formed on the cylindrical wall, and a bottom surface terminating the cylindrical wall, the bottom surface comprising a fluid director and a plurality of weak areas, the method comprising:
coupling the separation basket to a receiving tube;
inserting the collection device into the separation basket;
introducing a lysis buffer fluid into the separation basket;
sealing the collection device and the lysis buffer fluid in the separation basket; and
subjecting the separation basket and the receiving tube to a force such that at least one weak area breaks open in the separation basket, whereupon the lysis buffer fluid flows from the separation basket to the receiving tube.

10. The method according to claim 9 wherein subjecting the separation basket and the receiving tube to the force using a centrifuge.

11. The method according to claim 9, wherein subjecting the separation basket and the receiving tube to the force through pressurized air.

12. The method according to claim 9, wherein isolating the sample components of the solution from the collection device is achieved by submerging the collection device in the lysis buffer fluid to break a plurality of cells open and isolate the components.

13. The method according to claim 9, further comprising removing the separation basket from the receiving tube.

14. A sample separation assembly, comprising:
a separation basket comprising:
a cylindrical wall,
a flange extending from the cylindrical wall, and
a bottom surface terminating the cylindrical wall, the bottom surface comprising:
a fluid director disposed centrally on the bottom surface, and
a plurality of weak areas arranged radially about the fluid director, where
at least one of the plurality of weak areas fracture and create an opening when subjected to a force between 400 and 12,000 relative centrifugal force; and
a filter coupled to the separation basket; the filter configured to capture a first biological material.

15. The sample separation assembly of claim 14, wherein the filter is coupled to a filter retaining feature on an outer surface of the separation basket.

16. The sample separation assembly of claim 14, wherein the filter is coupled adjacent to a bottom exterior surface of the separation basket.

17. The sample separation assembly of claim 14, wherein the filter is coupled to a filter retaining feature on an inner surface of the separation basket.

18. The sample separation assembly of claim 14, wherein the filter is coupled to the separation basket via a snap fit.

19. The sample separation assembly of claim 14, wherein the filter is composed of PTFE.
